(19) United States
(12) Patent Application Publication
(10) Pub. No.: US 2023/0178282 A1
(43) Pub. Date: Jun. 8, 2023

(54) COMMON MODE CHOKE AND METHOD OF OPERATION

(71) Applicant: TDK Electronics AG, München (DE)

(72) Inventors: Fabian BECK, RÜTTENEN (CH); Tobias KORALEK, Ellwangen (Jagst) (DE)

(73) Assignee: TDK Electronics AG, München (DE)

(21) Appl. No.: 18/071,746

(22) Filed: Nov. 30, 2022

(30) Foreign Application Priority Data
Dec. 8, 2021 (DE) 102021132292.8

(51) Int. Cl. H01F 17/06; H01F 27/29

(52) U.S. Cl. CPC H01F 17/062; H01F 27/292; H01F 2017/0093

(57) ABSTRACT

A common mode choke with extended frequency range and improved reflection in mode conversion is specified. In this case, the common mode choke has a coil with three turns, where a coupling between a first turn and a second turn is different from a coupling between the second turn and an n-th turn, and so on.

### CROSS-REFERENCE TO RELATED APPLICATIONS

The present application claims the benefit of priority of German Patent Application No. 102021132292.8, filed on Dec. 8, 2021, the contents of which are incorporated by reference herein in its entirety.

### FIELD OF THE INVENTION

The invention relates to common mode chokes, especially chokes for attenuating unwanted signals in circuits, and methods for operating such chokes.

### BACKGROUND OF THE INVENTION

Common mode chokes are current-compensated chokes with two or more windings through which the operating current flows in opposite directions. This allows the magnetic fields of the corresponding windings to cancel each other out, so that interference currents in the same direction are essentially suppressed and desired currents in opposite directions can essentially pass through the choke. Such common mode chokes present very high inductance to common mode interference, so they are well suited for suppressing unwanted signals at inputs or outputs of switching power supplies, line filters or data lines.

Conventional common mode chokes have two windings wound on the same toroidal core or two discrete magnetic cores, each magnetically connected by parts of a yoke. Conventional common mode chokes have an operating range whose bandwidth is generally limited.

What is now desired are DC chokes whose operating range bandwidth is increased and/or whose electrical properties, for example insertion loss or reflection, are improved in the operating range.

To this end, an improved common mode choke is disclosed in the independent claim. Dependent claims indicate advantageous embodiments.

### SUMMARY OF THE INVENTION

The common mode choke comprises a first coil. The first coil has a first winding including a first turn, a second turn, and optionally further turns up to an n-th turn. A coupling between the first turn and the second turn is different from a coupling between the second turn and the n-th turn. Here, n is the number of turns and 2, 3 or greater. The number n of turns can be an integer. However, windings in which the last winding section is a half or quarter winding are also possible. That is, n=N+x, where N is an integer ≥2 and 0≤x<1. For example, x=0.1 or 0.25 or 0.5 or 0.75 or ⅓ or ⅔.

Such a common mode choke can be used especially if an extension of the operating range towards higher frequencies or an improvement of the electrical properties especially with regard to the mode conversion from common mode signals to push-pull signals is desired.

Common mode chokes generally have four electrical connections through which the chokes can be connected to an external circuit environment. An electrical component, especially a passive electrical component such as a common mode choke, can be considered a two-port network. In this case, two terminals of the choke form a first port, while the other two of the four terminals of the common mode choke form the second port. The electrical behavior of a two-port network can be represented by the scattering parameters, which together form the corresponding scattering matrices. In particular, the scattering parameters for devices that can operate with common mode signals and push-pull signals, respectively, can be represented by four different scattering parameter matrices. One scattering parameter matrix indicates the electrical behavior when a push-pull signal is considered at the first port and a push-pull signal is also considered at the second port. A fourth scattering parameter matrix relates to the case where common mode signals are considered at both the first and second ports. A second and a third scattering parameter matrix are relevant if a push-pull signal is considered at the first port and a common-mode signal is considered at the second port and vice versa, respectively.

The common mode choke specified above now makes it possible to extend the operating range towards higher frequencies in terms of insertion loss (S₂₁) for common mode signals at both ports.

Furthermore, the common mode choke described above allows the reflection (S₁₁) to be improved for mode conversion of common mode signals at the first port and push-pull signals at the second port.

In particular, it was recognized that the common mode choke described above has the improved electrical characteristics due to the different (e.g., internal) coupling of the windings.

The windings of the common mode choke are preferably connected relative to each other and to the operating current such that the choke presents a low impedance to push-pull signals and a high impedance to common mode signals.

The number of windings per coil is of course not limited to three. Rather, each of the two windings may have a plurality of other windings. The advantageous electrical properties described above are then obtained by different couplings between different windings or between pluralities of different windings of at least the first coil, but possibly also of the second coil.

Accordingly, it is possible for the common mode choke to include the second coil having a winding with a first turn, a second turn, and an n-th turn.

Similarly, it is possible that the common mode choke is configured such that a coupling between the first turn and the second turn of the second coil is different from a coupling between the second turn and the n-th turn of the second coil.

It is possible that the coupling referred to above is a magnetic and/or a capacitive coupling.

Different turns of a winding are generally arranged to enclose a coil interior in a longitudinal direction. A magnetic field is formed in this interior during the activity of the winding. As a result, different turns of a winding are magnetically coupled to each other via the common magnetic field in the common interior and/or exterior.

Moreover, the electrical conductors of such windings are generally arranged next to each other at a sufficiently small distance such that capacitive coupling between the different windings is possible.

The first winding is now arranged in a first space region and the n-th turn is now arranged in a second space region, so that a difference in coupling is obtained between the first and the second on the one hand in the first space region and between the second and the n-th turn on the other hand in the second space region.

In particular, the capacitive coupling that distinguishes the different turns relative to each other may be capacitive coupling.

The different coupling (magnetic and/or capacitive) can be obtained by the first turn, the second turn and the n-th turn having different lengths. In particular, the second turn can have a turn length that is between the turn length of the first turn and the turn length of the n-th turn.

It is possible that the common mode choke is designed in such a way that the winding lengths of the windings increase or decrease with their longitudinal position along the longitudinal axis around which the windings are wound. The increase or decrease can be linear with increasing position along the longitudinal axis. Other dependencies of the winding length on the longitudinal position, for example a dependency according to a power function (for example second power or third power) or an exponential dependency is also possible.

It is possible that the common mode choke is designed in such a way that the first coil comprises a magnetic core. The magnetic core is a magnetic core around which the winding of the first coil is wound.

It is possible that the common mode choke has a magnetic core in the first coil and the magnetic core has a variable circumference along a longitudinal axis. That is, the circumference of the magnetic core along the longitudinal axis varies with varying longitudinal position. In this regard, the circumference of the axis may increase or decrease with increasing position along the longitudinal axis. In particular, the circumference may increase or decrease linearly with increasing longitudinal position.

The magnetic core of the first coil and/or the winding of the first coil may be conically or trapezoidally shaped. In the case of a conically shaped magnetic core or winding, the shape has a substantially rectangular, circular, elliptical, or oval cross-section at each longitudinal position, with the radius or cross-sectional area of the cross-section increasing or decreasing, respectively, with increasing longitudinal position.

In the case of a trapezoidal magnetic core or trapezoidal shape of the winding, the magnetic core or winding has essentially a rectangular or square cross-section at each longitudinal position, which increases or decreases with increasing longitudinal position. The longitudinal direction can point essentially along a spatial direction. It is also possible for the longitudinal direction to be curved, for example when using a toroidal core, in which the longitudinal direction can in each case be considered locally as linear in approximation, but globally assumes a curvature corresponding to the curvature of the body of the toroidal core.

It is possible that the common mode choke has a second coil in addition to the first coil. The second coil is formed symmetrically or antisymmetrically to the first coil.

An antisymmetrical second coil means that the second coil is essentially identical to the first coil, but is connected in the opposite direction so that the working current flows through the two essentially identical coils in opposite directions and corresponding unwanted common mode interference is suppressed or even eliminated.

It is possible that the windings are made of a material selected from copper or an alloy with copper as the main component, silver or an alloy with silver as the main component.

It is further possible that in the common mode choke, the coil cores are made of a material selected from a magnetic material, ferrite, MnZn, NiZn, iron powder, an organic material enriched with a magnetic material, and a material comprising one of these materials as a main component.

It applies that the usual materials for windings, windings, connections and magnetic cores can also be used in the configuration of the common mode choke as specified above.

The improved common mode choke can thus use common materials so that common manufacturing processes can be used to produce the common mode choke. As a result, improved common mode chokes can be manufactured at low cost.

It is possible for the common mode choke to have four connections for interconnection with an external circuit environment. The common mode choke can be designed as an SMD component (SMD=Surface Mounted Device).

In particular, it is possible that the four connections are arranged on one side of the body of the common mode choke. In particular, it is possible for the four connections to be at the same height when viewed in the vertical direction, so that the choke can be soldered to a planar surface.

For this purpose, the common mode choke can have, in particular, four solder pads with corresponding metallization intended for soldering.

The common mode choke can be used in an integrated manner in electrical circuit environments. In particular, it is possible to improve insertion loss and/or mode conversion by varying the coupling between the first turn and the second turn relative to the coupling between the second turn and the n-th turn.

### BRIEF DESCRIPTION OF THE DRAWINGS

Details of specific embodiments and central principles of operation are explained in more detail with reference to schematic figures. They show:

FIG. 1 a common mode choke in which a first turn is located in a different spatial region compared to an n-th turn.

FIG. 2 a first winding with different winding lengths.

FIG. 3 a common mode choke with toroidal core of varied diameter along the longitudinal position.

FIG. 4 an exploded view of a common mode choke with a first coil core, each with a rectangular cross-section.

FIG. 5 a view of a common mode choke parallel to the vertical direction in which both coil cores and both windings are tapered.

FIG. 6 also shows a view of a common mode choke parallel to the vertical direction, in which the coil cores and coils are aligned antiparallel to each other.

FIG. 7 the insertion loss for common mode signals of a conventional choke (B) and a choke as described above (A).

FIG. 8 a comparison of the mode conversion reflection between a conventional common mode choke (B) and a choke as described above (A).

FIG. 9 an explanation of the term “mode conversion” from common mode signal to push-pull signal.

### DETAILED DESCRIPTION

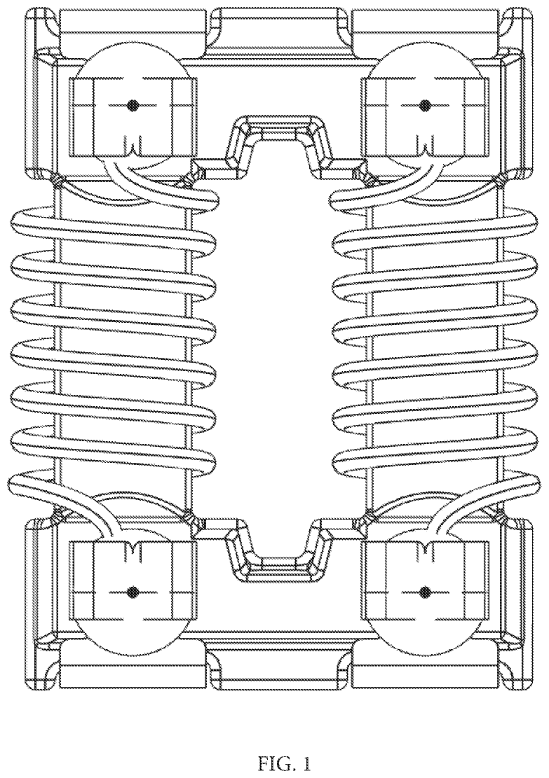

FIG. 1 shows a common mode choke GTD with a first winding WICK1 and a second winding WICK2. The first winding WICK1 has a first turn WIN1, a second turn WIN2 and an n-th turn WINS. The first winding is arranged in a first space region B1. The n-th turn is arranged in a second space region B2. The two spatial areas B1, B2 differ in that the coupling of the first turn WIN1 to the second turn WIN2 and of the n-th turn WIN3 to the second turn WIN2 are different.

The different coupling of the respective turns to the second turn results in the common mode choke having improved insertion loss in a higher frequency range on the one hand and reduced reflection (S₁₁) for the conversion of common mode signals in a wide frequency range.

The number of turns is of course not limited to two or three per winding. The windings may have a plurality, for example 10, 20, 50, 100, 200, 500 or 1000 turns. Preferably, the first winding has as many turns as the second winding. The second winding WICK2 can be symmetrical to the first winding WICK1 and can be connected in the same way or in an antiparallel way.

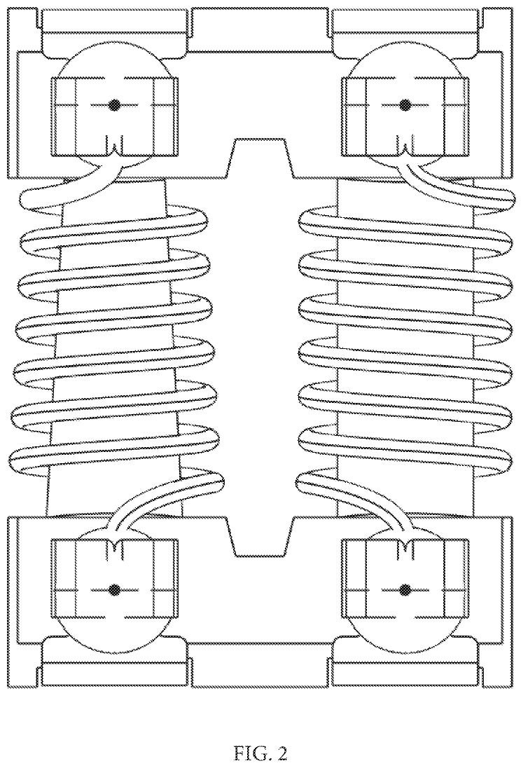

FIG. 2 shows a possible embodiment to make the couplings between the turns different. FIG. 2 shows the possibility to design the length of the turns differently, so that the second turn WIN2 has a turn length (length of the conductor of the turn) which is between the length of the n-th turn WIN3 and the length of the first turn WIN1.

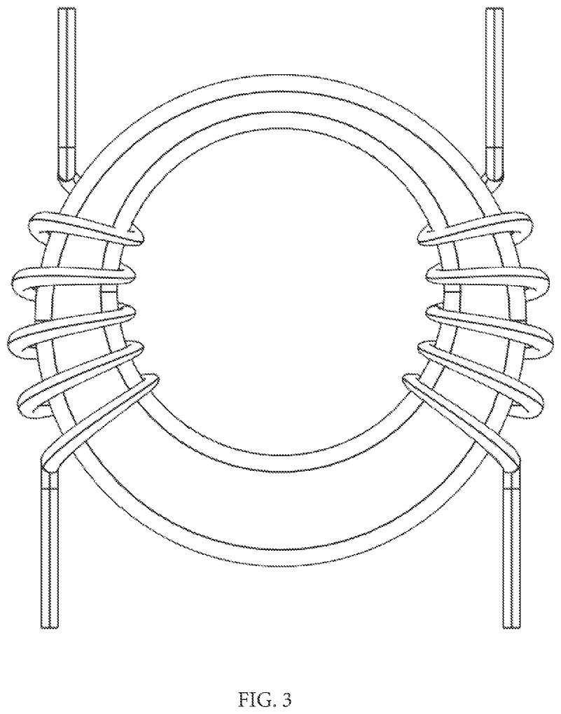

FIG. 3 shows another possibility to adjust the couplings differently. For example, the windings can have essentially the same, homogeneous winding structure, while the magnetic core is designed in such a way that its cross-sectional diameter increases or decreases along the longitudinal axis Z, respectively. In this case, the core can be designed as a toroidal core, where a part of the toroidal core is considered as a first magnetic core, that is, as a magnetic core of the first winding, while another part of the magnetic core is considered as a second magnetic core, that is, as a magnetic core of the second winding WICK2.

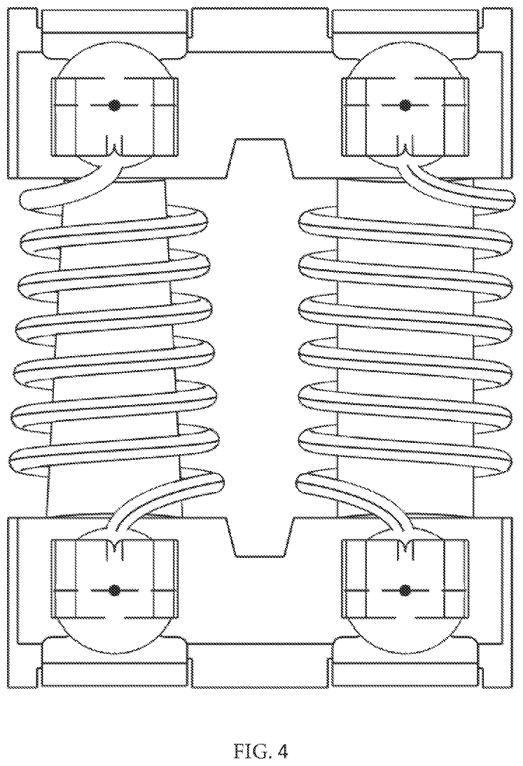

FIG. 4 shows another possibility to adjust the coupling accordingly. Thus, the first winding WICK2 is wound around a magnetic core which is trapezoidal in shape. In particular, the magnetic core K1 has a rectangular cross-section along each longitudinal position Z, with the area of the rectangle decreasing as the position along the longitudinal direction Z increases. The two magnetic cores are thereby magnetically coupled by corresponding sections J1, J2 of a yoke.

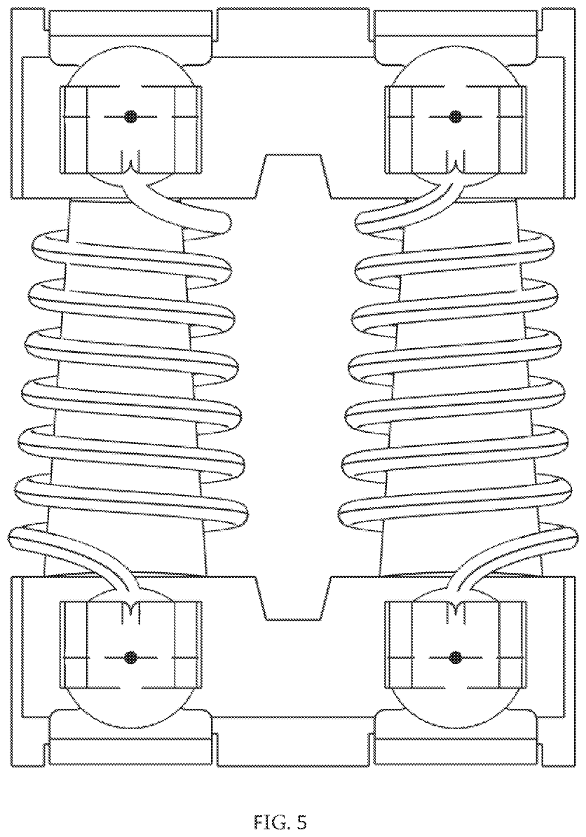

FIG. 5 shows the possibility of making both the windings and the magnetic cores conical. This means that the cross-section along the longitudinal axis is essentially circular with a radius that decreases as the longitudinal position Z increases. Furthermore, FIG. 5 shows the possibility of designing the common mode choke GTD as an SMD component. Thus, the common mode choke GTD has four external connections EA1, EA2, EA3, EA4, via which the common mode choke GTD can be electrically and mechanically connected to an external circuit environment via SMD methods. The four external connections EA1, EA2, EA3 and EA4 represent the connections of the two ports of the second port.

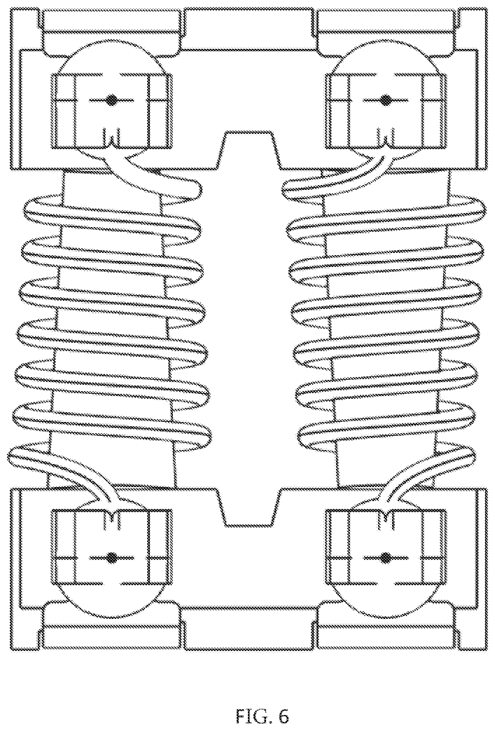

In contrast to FIG. 5, in which the directions of decrease of the diameters are arranged parallel, FIG. 6 shows an embodiment in which the directions are arranged antiparallel.

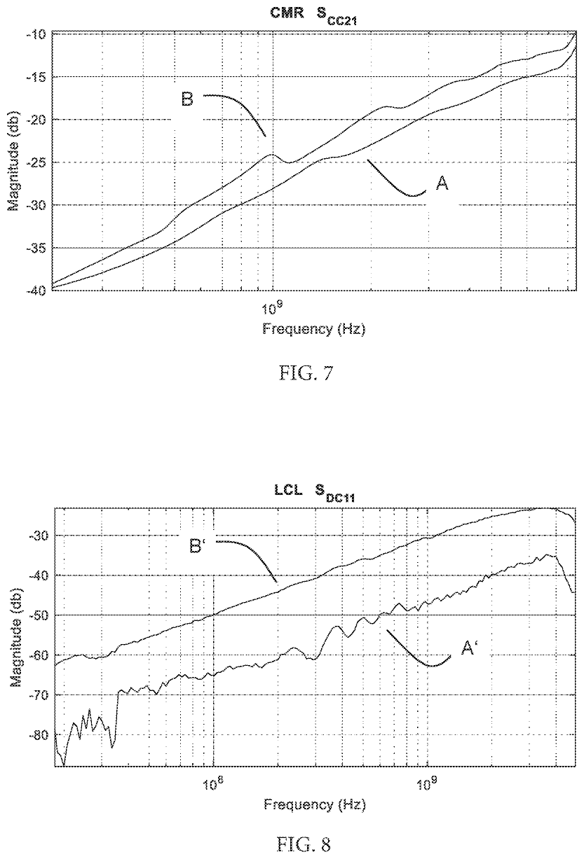

FIG. 7 shows the frequency-dependent insertion loss (S_{CC21}) for a frequency range from 104 to 1010 Hz (in logarithmic representation). It can be clearly seen that curve A, which represents the electrical characteristics of the improved common mode choke as described above, shows the reduced insertion loss for the frequency range from 200 MHz (compare the dashed ellipse). FIG. 7 shows the electrical characteristics for signals where common mode signals are considered at both the input port and the output port.

In contrast, FIG. 8 indicates the improvement in the suppression of reflection (S_{DC11}), considering common mode signals at the first port (input port) and also push-pull signals at the first port (output port). FIG. 8 thus clearly indicates that the common mode choke described above exhibits a substantial improvement in reflection during mode conversion. The improvement is 15 to 20 dB.

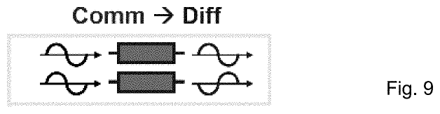

FIG. 9 illustrates the consideration of mode conversion with respect to FIG. 8: At the first port, the input port, common mode signals are considered, while at the second port, the output port, push-pull signals are considered. In common mode signals, an electrical signal propagates in two parallel signal lines essentially in phase. In push-pull signals, an electrical signal propagates in two parallel signal paths essentially in phase opposition, i.e. with a phase offset of 180°.

The common mode choke is not limited to the forms shown. Chokes having further circuit elements and/or further structural elements, for example for mechanical connection of core, winding or yoke, or chokes having further electrical contact surfaces or contact surfaces on different sides of the choke, also belong to the above description.

### LIST OF REFERENCE SIGNS

(A) Scattering matrix parameter S_{CCC21} of a conventional common mode choke
(A′) Scattering matrix parameter S_{DC11} of a conventional common mode choke
(B) Scattering matrix parameter S_{CC21} of an improved common mode choke
(B′) Scattering matrix parameter S_{DC11} of an improved common mode choke
B1, B2 First, second space area
Comm Common mode signal
Diff Push-pull (Counterclock) signal
EA1, EA2, EA3, EA4 First, second, third, fourth external connection
GTD Common mode choke
J1, J2 First, second part of magnetic yoke
K1, K2 First, second magnetic core
WICK1, WICK2 First, second winding
WIN1, WIN2, WINS First, second, n-th turn
Z Longitudinal direction

1. A common mode choke, comprising
a first coil with a winding from a first, a second to an n-th turn,
wherein a coupling between the first turn and the second turn is different from a coupling between the second turn and the n-th turn,
and wherein n is a number ≥2.

2. The common mode choke according to claim 1, comprising a second coil having a winding with a first, a second . . . and an n-th turn.

3. The common mode choke according to claim 1, wherein a coupling between the first turn and the second turn of the second coil is different from a coupling between the second turn and the n-th turn of the second coil.

4. The common mode choke according to claim 1, wherein the coupling is a magnetic and/or capacitive coupling.

5. The common mode choke according to claim 4, wherein the coupling is a capacitive coupling.

6. The common mode choke according to claim 1, wherein the first turn, the second turn and the n-th turn have different lengths.

7. The common mode choke according to claim 1, wherein the first coil comprises a magnetic core around which the winding of the first coil is wound.

8. The common mode choke according to claim 7, wherein the magnetic core of the first coil has a variable circumference along a longitudinal axis.

9. The common mode choke according to claim 8, wherein the magnetic core of the first coil has a linearly increasing circumference along the longitudinal axis with increasing longitudinal position.

10. The common mode choke according to claim 1, wherein the magnetic core of the first coil and/or the winding of the first coil is conical or trapezoidal in shape.

11. The common mode choke according to claim 1, comprising a second coil formed symmetrically or anti-symmetrically with respect to the first coil.

12. The common mode choke according to claim 1, wherein windings are made of a material selected from copper or an alloy with copper as main component, silver or an alloy with silver as main component.

13. The common mode choke according to claim 1, wherein coil cores consist of a material selected from
a magnetic material, Ferrite, MnZn, NiZn, iron powder,
an organic material enriched with a magnetic material, and
a material comprising one of these materials as a major constituent.

14. The common mode choke according to claim 1, comprising four terminals for interconnection with an external circuit environment, wherein the common mode choke is configured as an SMD component.

15. A method of operating a common mode choke, using a common mode choke according to claim 1.

16. A method of operating a common mode choke in which differential coupling between a first turn and a second turn relative to the second turn and an n-th turn improves insertion loss and/or mode conversion.
